(19) United States
(12) Patent Application Publication
(10) Pub. No.: US 2025/0386295 A1
(43) Pub. Date: Dec. 18, 2025

(54) LOW-POWER WAKE-UP SIGNAL INDICATING A PHYSICAL DOWNLINK CONTROL CHANNEL MONITORING ADAPTATION

(71) Applicant: Qualcomm Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/747,096

(22) Filed: Jun. 18, 2024

(51) Int. Cl. H04W 52/02; H04L 1/1607; H04W 72/231

(52) U.S. Cl. CPC H04W 52/0235; H04L 1/1614; H04W 72/231

(57) ABSTRACT

Various aspects of the present disclosure generally relate to wireless communication. Various aspects relate generally to a low-power wake-up signal (LP-WUS) indicating a PDCCH monitoring adaptation. Some aspects more specifically relate to the use of an LP-WUS to signal a PDCCH monitoring adaptation to be applied by a UE. In some aspects, a network node may transmit, and a UE may receive, an LP-WUS indicating a PDCCH monitoring adaptation to be applied by the UE. Here, the PDCCH monitoring adaptation is associated with at least one of PDCCH skipping or SSSG switching. The UE may then adapt PDCCH monitoring performed by the UE according to the PDCCH monitoring adaptation indicated in the LP-WUS. In some examples, by providing an LP-WUS indicating a PDCCH monitoring adaptation, the described techniques can be used to reduce or eliminate the use of CCEs in association with indicating PDCCH monitoring adaptations.

### FIELD OF THE DISCLOSURE

Aspects of the present disclosure generally relate to wireless communication and specifically relate to techniques, apparatuses, and methods associated with a low-power wake-up signal (LP-WUS) indicating a physical downlink control channel (PDCCH) monitoring adaptation.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

Physical downlink control channel (PDCCH) monitoring adaptation can be used to reduce PDCCH monitoring performed by a user equipment (UE) in order to, for example, reduce power consumption of the UE. One technique for PDCCH monitoring adaptation is search space set group (SSSG) switching (also referred to as PDCCH monitoring switching). SSSG switching allows a network node to change a PDCCH monitoring behavior of a UE by configuring particular PDCCH monitoring occasions in which the UE performs PDCCH monitoring through the use of different SSSGs. Another PDCCH monitoring adaptation technique is PDCCH skipping. PDCCH skipping allows a network node to indicate to the UE that the UE is to skip PDCCH monitoring for a duration of time. In some wireless communication systems, a PDCCH monitoring adaptation behavior to be applied by the UE can be signaled in downlink control information (DCI). However, signaling a PDCCH monitoring adaptation in DCI requires the use of control channel elements (CCEs) that could otherwise be used to transmit grants associated with data transmissions. As a result, the use of DCI to signal PDCCH monitoring adaptations can result in delay with respect to data communications in the network due to CCE consumption or blocking (for example, since there may not be sufficient resources available when a network node needs to transmit a grant to a UE). Further, there is ambiguity with respect to whether a UE should reset a connected-mode discontinuous reception (C-DRX) inactivation behavior when the UE receives DCI indicating a PDCCH monitoring adaptation, as well as with respect to when a UE should apply a PDCCH monitoring adaptation in case of a hybrid automatic repeat request (HARQ) retransmission, as application of a PDCCH monitoring adaptation can increase latency or otherwise reduce network efficiency in such scenarios.

### SUMMARY

Some aspects described herein relate to a method of wireless communication performed at a user equipment (UE). The method may include receiving a low-power wake-up signal (LP-WUS) indicating a physical downlink control channel (PDCCH) monitoring adaptation to be applied by the UE, where the PDCCH monitoring adaptation is associated with at least one of PDCCH skipping or search space set group (SSSG) switching. The method may include adapting PDCCH monitoring performed by the UE according to the PDCCH monitoring adaptation indicated in the LP-WUS.

Some aspects described herein relate to a method of wireless communication performed at a network node. The method may include enabling LP-WUSs indicating PDCCH monitoring adaptations for a UE. The method may include transmitting an LP-WUS indicating a PDCCH monitoring adaptation to be applied by the UE, where the PDCCH monitoring adaptation is associated with at least one of PDCCH skipping or SSSG switching.

Some aspects described herein relate to an apparatus at a UE for wireless communication. The UE may include one or more memories storing processor-executable code and one or more processors coupled with the one or more memories. At least one processor of the one or more processors may be individually or collectively operable to cause the UE to receive an LP-WUS indicating a PDCCH monitoring adaptation to be applied by the UE, wherein the PDCCH monitoring adaptation is associated with at least one of PDCCH skipping or SSSG switching. The one or more processors may be individually or collectively operable to cause the UE to adapt PDCCH monitoring performed by the UE according to the PDCCH monitoring adaptation indicated in the LP-WUS.

Some aspects described herein relate to an apparatus at a network node for wireless communication. The network node may include one or more memories storing processor-executable code and one or more processors coupled with the one or more memories. At least one processor of the one or more processors may be individually or collectively operable to cause the network node to enable LP-WUSs indicating PDCCH monitoring adaptations for a UE. The one or more processors may be individually or collectively operable to cause the network node to transmit an LP-WUS indicating a PDCCH monitoring adaptation to be applied by the UE, wherein the PDCCH monitoring adaptation is associated with at least one of PDCCH skipping or SSSG switching.

Some aspects described herein relate to a non-transitory computer-readable medium that stores a set of instructions for wireless communication by a UE. The set of instructions, when executed by one or more processors of the UE, may cause the UE to receive an LP-WUS indicating a PDCCH monitoring adaptation to be applied by the UE, wherein the PDCCH monitoring adaptation is associated with at least one of PDCCH skipping or SSSG switching. The set of instructions, when executed by one or more processors of the UE, may cause the UE to adapt PDCCH monitoring performed by the UE according to the PDCCH monitoring adaptation indicated in the LP-WUS.

Some aspects described herein relate to a non-transitory computer-readable medium that stores a set of instructions for wireless communication by a network node. The set of instructions, when executed by one or more processors of the network node, may cause the network node to enable LP-WUSs indicating PDCCH monitoring adaptations for a UE. The set of instructions, when executed by one or more processors of the network node, may cause the network node to transmit an LP-WUS indicating a PDCCH monitoring adaptation to be applied by the UE, wherein the PDCCH monitoring adaptation is associated with at least one of PDCCH skipping or SSSG switching.

Some aspects described herein relate to an apparatus for wireless communication. The apparatus may include means for receiving an LP-WUS indicating a PDCCH monitoring adaptation to be applied by the UE, wherein the PDCCH monitoring adaptation is associated with at least one of PDCCH skipping or SSSG switching. The apparatus may include means for adapting PDCCH monitoring performed by the UE according to the PDCCH monitoring adaptation indicated in the LP-WUS.

Some aspects described herein relate to an apparatus for wireless communication. The apparatus may include means for enabling LP-WUSs indicating PDCCH monitoring adaptations for a UE. The apparatus may include means for transmitting an LP-WUS indicating a PDCCH monitoring adaptation to be applied by the UE, wherein the PDCCH monitoring adaptation is associated with at least one of PDCCH skipping or SSSG switching.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating an example of a low-power wakeup radio (LP-WUR) and a low-power wakeup signal (LP-WUS).

FIG. 4 is a diagram illustrating an example associated with an LP-WUS indicating a physical downlink control channel (PDCCH) monitoring adaptation.

FIG. 5 is a flowchart illustrating an example process performed, for example, at a UE or an apparatus of a UE that supports an LP-WUS indicating a PDCCH monitoring adaptation.

FIG. 6 is a flowchart illustrating an example process performed, for example, at a network node or an apparatus of a network node that supports an LP-WUS indicating a PDCCH monitoring adaptation.

FIG. 7 is a diagram of an example apparatus for wireless communication that supports an LP-WUS indicating a PDCCH monitoring adaptation.

FIG. 8 is a diagram of an example apparatus for wireless communication that supports an LP-WUS indicating a PDCCH monitoring adaptation in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Physical downlink control channel (PDCCH) monitoring adaptation can be used to reduce PDCCH monitoring performed by a user equipment (UE) in order to, for example, reduce power consumption of the UE. One technique for PDCCH monitoring adaptation is search space set group (SSSG) switching (also referred to as PDCCH monitoring switching). SSSG switching allows a network node to change a PDCCH monitoring behavior of a UE by configuring particular PDCCH monitoring occasions in which the UE performs PDCCH monitoring through the use of different SSSGs. For example, the network node can change the PDCCH monitoring behavior of the UE so that the UE performs PDCCH monitoring in a comparatively sparse set of PDCCH monitoring occasions (for example, rather than all PDCCH monitoring occasions). Another PDCCH monitoring adaptation technique is PDCCH skipping. PDCCH skipping allows a network node to indicate to the UE that the UE is to skip PDCCH monitoring for a duration of time.

In some wireless communication systems, a PDCCH monitoring adaptation behavior to be applied by the UE can be signaled in downlink control information (DCI). Conventionally, DCI can indicate one of the following PDCCH monitoring adaptation behaviors: (1) PDCCH skipping is not activated/triggered; (2) PDCCH skipping should be performed for a duration of X milliseconds (ms) (with X being configured via radio resource control (RRC) signaling); (3) PDCCH monitoring should not be performed for a SSSG1 and SSSG2 and PDCCH monitoring should be performed for SSSG0; (4) PDCCH monitoring should not be performed for a SSSG0 and SSSG2 and PDCCH monitoring should be performed for SSSG1; and (5) PDCCH monitoring should not be performed for a SSSG0 and SSSG1 and PDCCH monitoring should be performed for SSSG0.

However, signaling a PDCCH monitoring adaptation in DCI requires the use of control channel elements (CCEs) that could otherwise be used to transmit grants associated with data transmissions. As a result, the use of DCI to signal PDCCH monitoring adaptations can result in delay with respect to data communications in the network due to CCE consumption or blocking (for example, since there may not be sufficient resources available when a network node needs to transmit a grant to a UE). Further, there is ambiguity with respect to whether a UE should reset a connected-mode discontinuous reception (C-DRX) inactivation behavior when the UE receives DCI indicating a PDCCH monitoring adaptation, as well as with respect to when a UE should apply a PDCCH monitoring adaptation in case of a hybrid automatic repeat request (HARQ) retransmission, as application of a PDCCH monitoring adaptation can increase latency or reduce overall network efficiency in such scenarios.

Various aspects relate generally to a low-power wake-up signal (LP-WUS) indicating a PDCCH monitoring adaptation. Some aspects more specifically relate to the use of an LP-WUS to signal a PDCCH monitoring adaptation to be applied by a UE. In some aspects, a network node may transmit, and a UE may receive, an LP-WUS indicating a PDCCH monitoring adaptation to be applied by the UE. Here, the PDCCH monitoring adaptation is associated with at least one of PDCCH skipping or SSSG switching. The UE may then adapt PDCCH monitoring performed by the UE according to the PDCCH monitoring adaptation indicated in the LP-WUS.

Particular aspects of the subject matter described in this disclosure can be implemented to realize one or more of the following potential advantages. In some examples, by providing an LP-WUS indicating a PDCCH monitoring adaptation, the described techniques can be used to reduce or eliminate the use of CCEs in association with indicating PDCCH monitoring adaptations. As a result, CCE consumption or blocking is reduced, meaning that availability of CCEs for transmitting grants to a UE is increased, thereby reducing latency with respect to data communications in the network. Further, the use of LP-WUSs for indicating PDCCH monitoring adaptations removes ambiguity with respect to reset of a C-DRX inactivation behavior as well as with respect to application of a PDCCH monitoring adaptation in case of a HARQ retransmission, meaning that latency in such scenarios is reduced.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

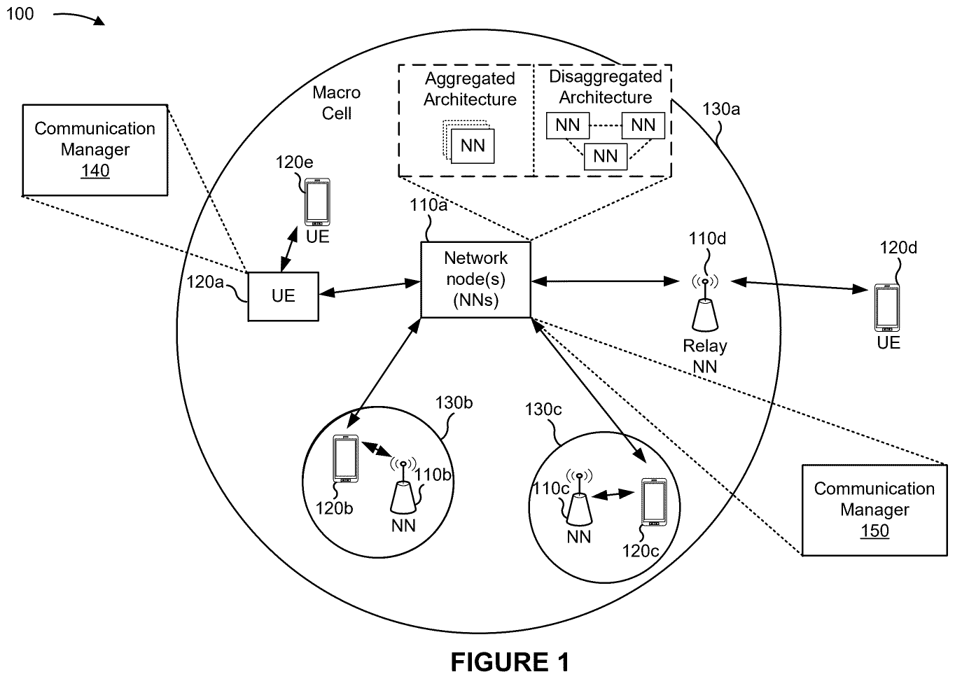

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may receive an LP-WUS indicating a PDCCH monitoring adaptation to be applied by the UE, wherein the PDCCH monitoring adaptation is associated with at least one of PDCCH skipping or SSSG switching; and adapt PDCCH monitoring performed by the UE according to the PDCCH monitoring adaptation indicated in the LP-WUS. Additionally or alternatively, the communication manager 140 may perform one or more other operations described herein.

In some aspects, the network node 110 may include a communication manager 150. As described in more detail elsewhere herein, the communication manager 150 may enable LP-WUSs indicating PDCCH monitoring adaptations for a UE 120; and transmit an LP-WUS indicating a PDCCH monitoring adaptation to be applied by the UE 120, wherein the PDCCH monitoring adaptation is associated with at least one of PDCCH skipping or SSSG switching. Additionally or alternatively, the communication manager 150 may perform one or more other operations described herein.

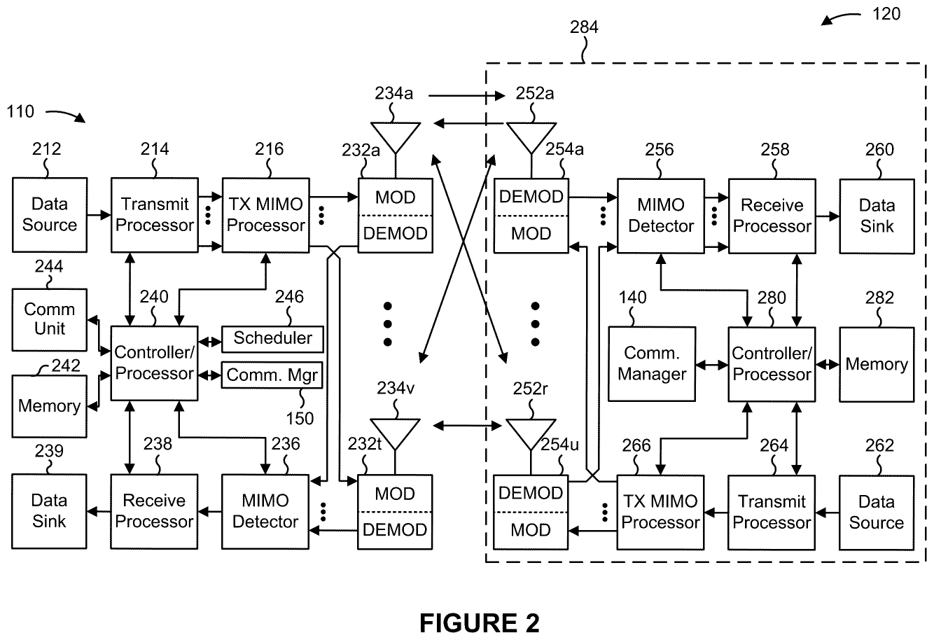

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a medium access control (MAC) control element (MAC-CE) communication, an RRC communication, or another type of uplink communication. Uplink signals may be transmitted on a physical uplink scheduled channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

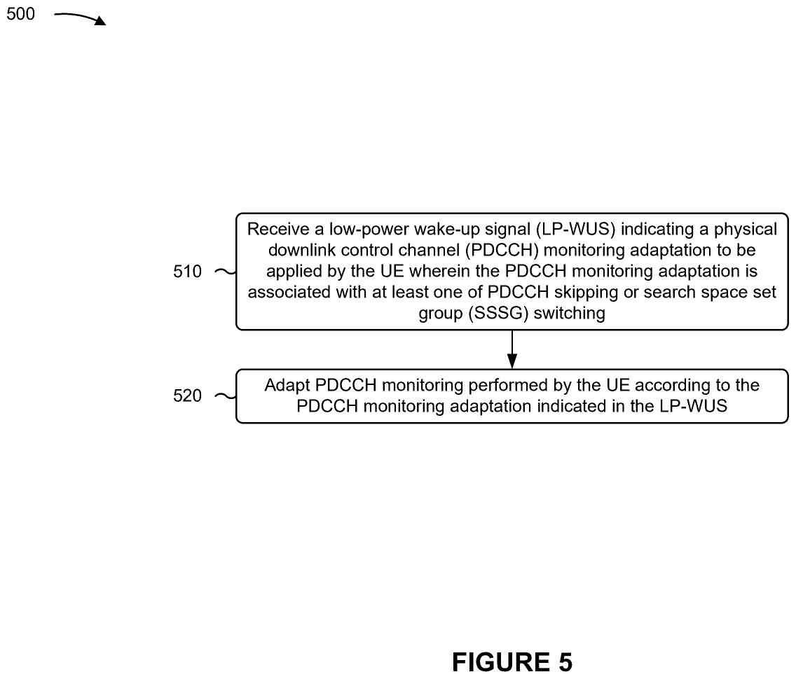

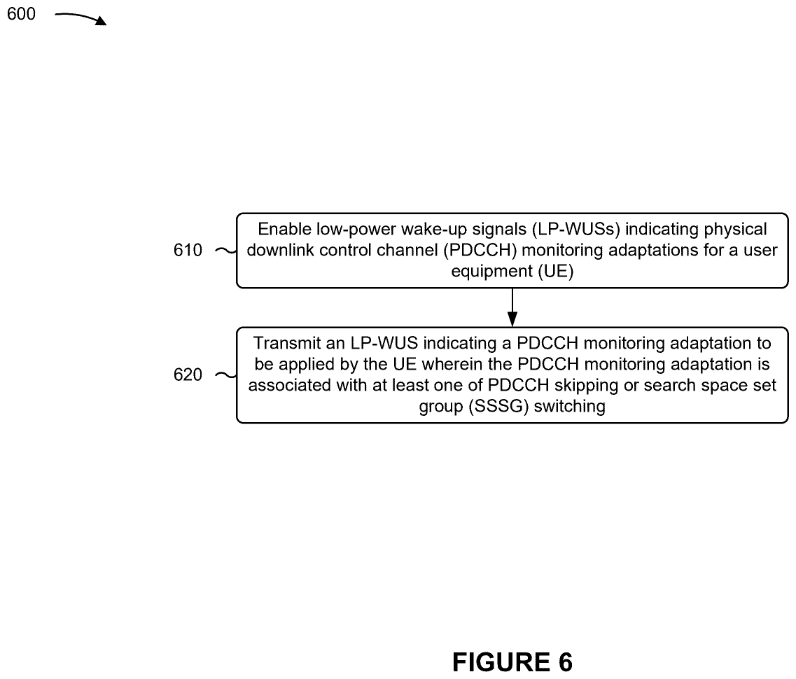

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with an LP-WUS indicating a PDCCH monitoring adaptation, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 500 of FIG. 5, process 600 of FIG. 6, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

In some aspects, the UE 120 includes means for receiving an LP-WUS indicating a PDCCH monitoring adaptation to be applied by the UE 120, wherein the PDCCH monitoring adaptation is associated with at least one of PDCCH skipping or SSSG switching; and/or means for adapting PDCCH monitoring performed by the UE 120 according to the PDCCH monitoring adaptation indicated in the LP-WUS. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for enabling LP-WUSs indicating PDCCH monitoring adaptations for a UE 120; and/or means for transmitting an LP-WUS indicating a PDCCH monitoring adaptation to be applied by the UE 120, wherein the PDCCH monitoring adaptation is associated with at least one of PDCCH skipping or SSSG switching. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

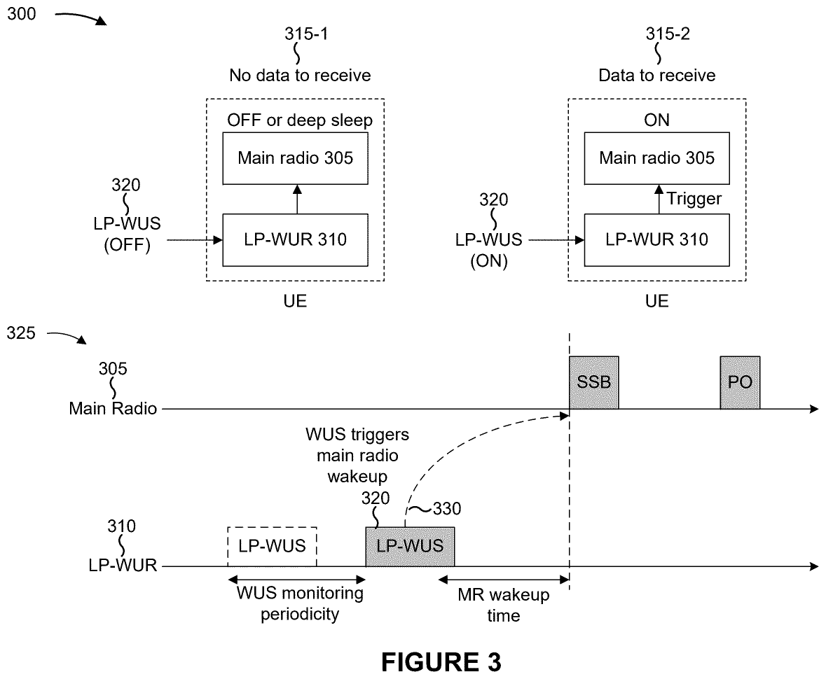

FIG. 3 is a diagram illustrating an example 300 of a low-power wakeup radio (LP-WUR) and an LP-WUS, in accordance with the present disclosure. As shown in FIG. 3, a UE (such as UE 120) may be equipped with a communication system that includes a main radio (illustrated as “MR”) 305 and an LP-WUR 310 to reduce power consumption and enable low latency. For example, power saving and low latency are often conflicting goals, because placing one or more components into a sleep state more often, in order to reduce power consumption, also increases latency (for example, because data cannot be transmitted and/or received while the one or more components are in the sleep state), and because reducing the time that one or more components spend in a sleep state, in order to reduce latency, can lead to increased power consumption. Accordingly, as shown in FIG. 3, the UE may be equipped with the LP-WUR 310, which may be considered a companion receiver that can be used with a main radio 305 to reduce power consumption and latency.

For example, in some aspects, the UE may generally use the main radio 305 to transmit and/or receive user data, and the main radio 305 may be turned off or operated in a deep sleep state unless there is user data to transmit and/or receive. Furthermore, the LP-WUR 310 may serve as a simple wakeup receiver for the main radio 305, and the LP-WUR 310 may be active and monitoring for an LP-WUS while the main radio 305 is off or in the deep sleep state. For example, reference number 315-1 indicates a first state associated with the main radio 305 and the LP-WUR 310, where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 based on detecting the LP-WUS 320. Accordingly, the main radio 305 may then transmit and/or receive user data.

In general, the LP-WUR 310 may consume very little power (for example a target power consumption less than 100 microwatts (μW) in the active state), which may be achieved using simple modulation schemes (for example, on-off keying (OOK)), a narrow bandwidth (for example, less than 5 MHz), and/or other suitable techniques. In this way, the LP-WUR 310 can be used to reduce the time that the main radio 305 spends in an on state and/or may avoid unnecessarily waking the main radio 305 from the off or deep sleep state when there is no user data to transmit or receive, which tends to be costly from a power consumption perspective. Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor a low power synchronization signal (LP-SS) for time and frequency tracking and radio resource management (RRM) measurement. In this way, by monitoring the LP-SS, serving cell and/or neighbor cell monitoring can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A UE that uses an OOK WUR may detect the phase of a received signal by activating the MR 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown at reference 325, one application of the LP-WUR 310 is to monitor the LP-WUS 320 for paging monitoring, which can be used to reduce unnecessary paging reception performed by the main radio 305. For example, as shown in FIG. 3, the LP-WUR 310 may be configured to monitor for an LP-WUS 320 (while the main radio 305 is off or in a deep sleep state) according to a WUS monitoring periodicity. For example, the LP-WUR 310 may monitor for the LP-WUS 320 in periodic LP-WUS monitoring occasions that are spaced in time according to the WUS monitoring periodicity. Alternatively, although not explicitly shown in FIG. 3, the LP-WUR 310 may be configured to continuously monitor for the LP-WUS 320. In general, a network node may transmit an LP-WUS 320 to a UE only in cases where there is a paging message that needs to be sent to the UE while the UE is in an idle or inactive state (such as an RRC idle or RRC inactive state). In such cases, as shown at reference 330, the LP-WUR 310 may receive and detect the LP-WUS 320, which may trigger the LP-WUR 310 to wake up the main radio 305. In some aspects, the LP-WUS 320 may be a sequence-based WUS, which may include a predefined set of sequences (implemented, for example, using OOK modulation and/or phase modulation). As shown, the main radio 305 may wake up after a main radio wakeup time, and may then start to monitor one or more synchronization signal block (SSB) transmissions to obtain synchronization with the network node before monitoring and receiving the paging message in a subsequent PO. Otherwise, in cases where the LP-WUR 310 does not detect the LP-WUS 320, the main radio 305 may remain in the deep sleep state to save power.

In some aspects, the techniques and apparatuses described herein for an LP-WUS indicating a PDCCH monitoring adaptation can be applied using an LP-WUR and an LP-WUS as described with respect to FIG. 3.

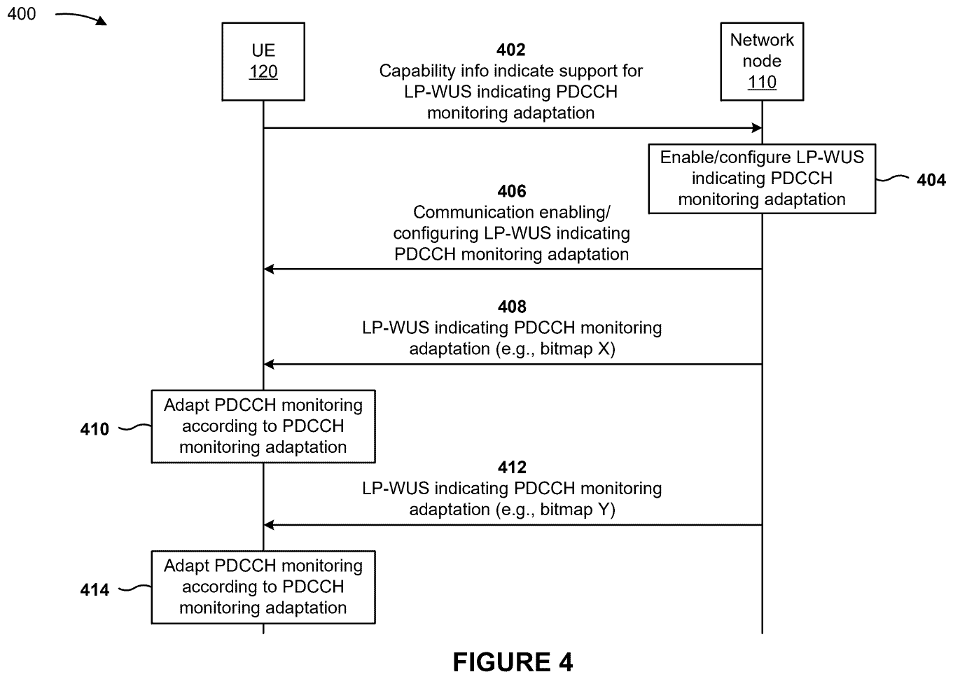

FIG. 4 is a diagram illustrating an example 400 associated with an LP-WUS indicating a PDCCH monitoring adaptation, in accordance with the present disclosure. As shown in FIG. 4, example 400 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In a first operation 402, the UE 120 may transmit, and the network node 110 may receive, capability information including an indication that the UE 120 supports LP-WUSs indicating PDCCH monitoring adaptations. That is, the UE 120 may transmit capability information indicating that the UE 120 has the capability to receive and process LP-WUSs indicating PDCCH monitoring adaptations. In this way, the network node 110 may be informed that the UE 120 is capable of receiving LP-WUSs indicating PDCCH monitoring adaptations (for example, rather than or in addition to receiving PDCCH monitoring adaptation indications via DCI).

In some aspects, the UE 120 may transmit, and the network node 110 may receive, a communication indicating a preferred PDCCH monitoring adaptation (for example, a PDCCH monitoring adaptation preferred by the UE 120). In some aspects, the UE 120 may derive the preferred PDCCH monitoring adaptation based at least in part on, for example, a traffic pattern prediction associated with the UE 120 (for example, a prediction for a traffic pattern of the UE 120), power consumption of the UE 120 (for example, an actual power consumption of the UE 120 or a predicted power consumption of the UE 120, among other examples), or a traffic latency requirement associated with the UE 120 (for example, a latency requirement for traffic associated with the UE 120).

In a second operation 404, the network node 110 may enable LP-WUSs indicating PDCCH monitoring adaptations for the UE 120. For example, the network node 110 may enable LP-WUSs indicating PDCCH monitoring adaptations for the UE 120. In some aspects, the network node 110 may enable LP-WUSs indicating PDCCH monitoring adaptations for the UE 120 based at least in part on a traffic pattern associated with the UE 120. Additionally or alternatively, the network node 110 may enable LP-WUSs indicating PDCCH monitoring adaptations for the UE 120 based at least in part on a radio condition associated with the UE 120. Additionally or alternatively, the network node 110 may enable LP-WUSs indicating PDCCH monitoring adaptations for the UE 120 based at least in part on a mobility characteristic associated with the UE 120 (for example, whether the UE 120 is in a near cell, a middle cell, or a far cell associated with the network node 110). Additionally, or alternatively, the network node 110 may enable LP-WUSs indicating PDCCH monitoring adaptations for the UE 120 based at least in part on a CCE usage characteristic (e.g., CCE usage associated with or attributable to the UE 120). Additionally, or alternatively, the network node 110 may enable LP-WUSs indicating PDCCH monitoring adaptations for the UE 120 based at least in part on a PDCCH blocking characteristic (e.g., PDCCH blocking associated with or attributable to the UE 120).

In a third operation 406, the network node 110 may transmit, and the UE 120 may receive, a communication associated with enabling or configuring LP-WUSs indicating PDCCH monitoring adaptations on the UE 120. For example, the network node 110 may transmit, and the UE 120 may receive, RRC signaling (for example, an RRC reconfiguration message) indicating that LP-WUSs indicating PDCCH monitoring adaptations are enabled for the UE 120. In some aspects, the communication may include one or more parameters associated with applying a PDCCH monitoring adaptation. For example, the communication may indicate a PDCCH skipping duration (for example, in ms) to be applied in a scenario in which the UE 120 is indicated, via an LP-WUS, to perform PDCCH skipping.

In a fourth operation 408, the network node 110 may transmit, and the UE 120 may receive, an LP-WUS indicating a PDCCH monitoring adaptation to be applied by the UE 120. In some aspects, the network node 110 may derive the PDCCH monitoring adaptation to be applied by the UE 120 based at least in part on, for example, a traffic pattern associated with the UE 120, a radio condition associated with the UE 120, a mobility characteristic associated with the UE 120 (for example, whether the UE 120 is in a near cell, a middle cell, or a far cell associated with the network node 110), a CCE usage characteristic (e.g., CCE usage associated with or attributable to the UE 120), or a PDCCH blocking characteristic (e.g., PDCCH blocking associated with or attributable to the UE 120). Additionally, or alternatively, the network node 110 may derive the PDCCH monitoring adaptation to be applied by the UE 120 based at least in part on a preferred PDCCH monitoring adaptation indicated by the UE 120 (for example, such that the network node 110 derives the PDCCH monitoring adaptation based at least in part on the PDCCH monitoring adaptation preferred by the UE 120).

In some aspects, the PDCCH monitoring adaptation is associated with PDCCH skipping or SSSG switching. In one example, the PDCCH monitoring adaptation may indicate that the UE 120 is to deactivate or cease PDCCH skipping. In another example, the PDCCH monitoring adaptation may indicate that the UE 120 is to perform PDCCH skipping for a duration of time (for example, a duration configured via RRC signaling or a duration indicated in the LP-WUS, among other examples). In another example, the PDCCH monitoring adaptation may indicate that the UE 120 is to refrain from monitoring one or more search space sets associated with one or more particular SSSGs and is to perform monitoring of one or more other search space sets associated with one or more other particular SSSGs (for example, so as to cause the UE 120 to monitor a quantity of n PDCCH occasions per slot, where n=1, 2, 4, or 8, among other examples). In some aspects, the PDCCH monitoring adaptation may comprise a combination of PDCCH skipping and SSSG switching. For example, the PDCCH monitoring adaptation may indicate that the UE 120 is to perform PDCCH skipping for a duration of time, after which the UE 120 is to refrain from monitoring a search space set associated with a first SSSG and a search space set associated with a second SSSG, and is to perform monitoring of a search space set associated with a third SSSG.

In some aspects, the PDCCH monitoring adaptation is indicated in the LP-WUS via a bitmap (for example, a bitmap comprising a plurality of bit values). In one example, one or more bit values carried in the bitmap may indicate a duration (for example, in ms) during which the UE 120 is to perform PDCCH skipping. In another example, one or more bit values carried in the bitmap may indicate a monitoring scheme associated with SSSG switching (for example, one or more SSSGs in which the UE 120 is to refrain from performing PDCCH monitoring, one or more SSSGs in which the UE 120 is to perform PDCCH monitoring).

In a fifth operation 410, the UE 120 may adapt PDCCH monitoring performed by the UE 120 according to the PDCCH monitoring adaptation indicated in the LP-WUS. That is, the UE 120 may adapt PDCCH monitoring according to the PDCCH monitoring adaptation carried in the LP-WUS. For example, the UE 120 may adapt PDCCH monitoring performed by the UE 120 by performing PDCCH skipping according to the PDCCH monitoring adaptation indicated in the LP-WUS. As another example, the UE 120 may adapt PDCCH monitoring performed by the UE 120 by refraining from monitoring one or more search space sets or monitoring one or more search space sets according to the PDCCH monitoring indicated in the LP-WUS.

In a sixth operation 412, the network node 110 may transmit, and the UE 120 may receive, a second LP-WUS indicating a second PDCCH monitoring adaptation to be applied by the UE 120. For example, after transmitting the LP-WUS indicating the PDCCH monitoring adaptation to the UE 120, the network node 110 may decide that a second (different) PDCCH monitoring adaptation is to be applied by the UE 120, and may transmit a second LP-WUS indicating the second PDCCH monitoring adaptation to be applied by the UE 120. In some aspects, the network node 110 may derive that the second PDCCH monitoring adaptation is to be applied by the UE 120 based at least in part on the traffic pattern associated with the UE 120 (for example, a change in the traffic pattern), the radio condition associated with the UE 120 (for example, a change in the radio condition), a mobility characteristic associated with the UE 120 (for example, a change in the mobility characteristic), a CCE usage characteristic change (e.g., a change in CCE usage associated with or attributable to the UE 120), or a PDCCH blocking characteristic change (e.g., a change in PDCCH blocking associated with or attributable to the UE 120). In some aspects, the second PDCCH monitoring adaptation may be indicated in the LP-WUS via a bitmap carrying a plurality of bit values. Here, values carried in the bitmap associated with the second PDCCH monitoring adaptation may be different from values carried in the bitmap associated with the first PDCCH monitoring adaptation (for example, the second bitmap can carry different bit values so as to update or modify the PDCCH monitoring adaptation applied by the UE 120).

In some aspects, the second LP-WUS is transmitted by the network node 110 and received by the UE 120 during a period of time in which the UE 120 is not performing PDCCH monitoring. That is, in some aspects, an LP-WUS indicating a PDCCH monitoring adaptation may be communicated during a period of time that the UE 120 is not performing PDCCH monitoring (for example, during a period of time in which the UE 120 is performing PDCCH skipping, during a period of time in which a main radio of the UE 120 is powered off or is in a low-power state, among other examples). Additionally or alternatively, the second LP-WUS is transmitted by the network node 110, and received by the UE 120, during a period of time in which the UE 120 is performing PDCCH monitoring. That is, in some aspects, an LP-WUS indicating a PDCCH monitoring adaptation may be communicated during a period of time that the UE 120 is performing PDCCH monitoring. In this way, the use of LP-WUSs to indicate PDCCH monitoring adaptations enables dynamic adaptation of the PDCCH monitoring adaptation applied by the UE 120 (for example, when a main radio of the UE 120 is powered off, when the main radio of the UE 120 is operating in a low-power state, or when the UE 120 is operating in an RRC connected mode, among other examples).

In a seventh operation 414, the UE 120 may adapt the PDCCH monitoring behavior performed by the UE 120 according to the second PDCCH monitoring adaptation indicated in the second LP-WUS. That is, the UE 120 may adapt PDCCH monitoring according to the second PDCCH monitoring adaptation carried in the second LP-WUS.

FIG. 5 is a flowchart illustrating an example process 500 performed, for example, at a UE or an apparatus of a UE that supports an LP-WUS indicating a PDCCH monitoring adaptation in accordance with the present disclosure. Example process 500 is an example where the apparatus or the UE (for example, UE 120) performs operations associated with an LP-WUS indicating a PDCCH monitoring adaptation.

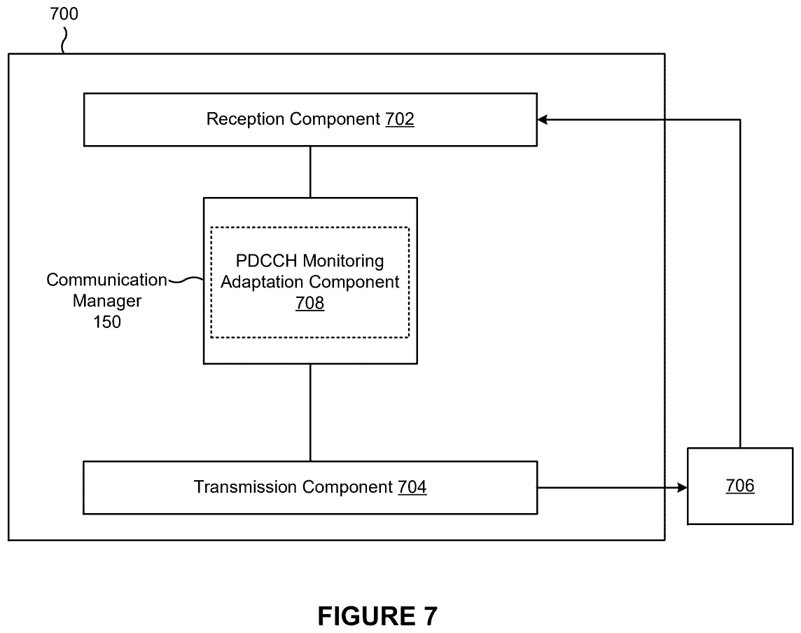

As shown in FIG. 5, in some aspects, process 500 may include receiving an LP-WUS indicating a PDCCH monitoring adaptation to be applied by the UE, wherein the PDCCH monitoring adaptation is associated with at least one of PDCCH skipping or SSSG switching (block 510). For example, the UE (such as by using communication manager 140 or reception component 702, depicted in FIG. 7) may receive an LP-WUS indicating a PDCCH monitoring adaptation to be applied by the UE, wherein the PDCCH monitoring adaptation is associated with at least one of PDCCH skipping or SSSG switching, as described above.

As further shown in FIG. 5, in some aspects, process 500 may include adapting PDCCH monitoring performed by the UE according to the PDCCH monitoring adaptation indicated in the LP-WUS (block 520). For example, the UE (such as by using communication manager 140 or PDCCH monitoring adaptation component 708, depicted in FIG. 7) may adapt PDCCH monitoring performed by the UE according to the PDCCH monitoring adaptation indicated in the LP-WUS, as described above.

Process 500 may include additional aspects, such as any single aspect or any combination of aspects described below or in connection with one or more other processes described elsewhere herein.

In a first additional aspect, process 500 includes transmitting capability information including an indication that the UE supports LP-WUSs indicating PDCCH monitoring adaptations.

In a second additional aspect, alone or in combination with the first aspect, process 500 includes receiving a communication associated with enabling or configuring LP-WUSs indicating PDCCH monitoring adaptations on the UE.

In a third additional aspect, alone or in combination with one or more of the first and second aspects, the PDCCH monitoring adaptation indicates that the UE is to at least one of: deactivate or cease PDCCH skipping, perform PDCCH skipping for a duration of time, or refrain from monitoring one or more search space sets associated with one or more particular SSSGs, and perform monitoring of one or more other search space sets associated with one or more other particular SSSGs.

In a fourth additional aspect, alone or in combination with one or more of the first through third aspects, the PDCCH monitoring adaptation is indicated in the LP-WUS via a bitmap.

In a fifth additional aspect, alone or in combination with one or more of the first through fourth aspects, one or more bit values carried in the bitmap indicate a duration associated with PDCCH skipping.

In a sixth additional aspect, alone or in combination with one or more of the first through fifth aspects, one or more bit values carried in the bitmap indicate a monitoring scheme associated with SSSG switching.

In a seventh additional aspect, alone or in combination with one or more of the first through sixth aspects, the LP-WUS is a first LP-WUS and the PDCCH monitoring adaptation is a first PDCCH monitoring adaptation, and process 500 includes receiving a second LP-WUS indicating a second PDCCH monitoring adaptation to be applied by the UE, the second LP-WUS being received after the first LP-WUS, and adapting the PDCCH monitoring performed by the UE according to the second PDCCH monitoring adaptation indicated in the second LP-WUS.

In an eighth additional aspect, alone or in combination with one or more of the first through seventh aspects, the second LP-WUS is received during a period of time in which the UE is not performing PDCCH monitoring.

In a ninth additional aspect, alone or in combination with one or more of the first through eighth aspects, the second LP-WUS is received during a period of time in which the UE is performing PDCCH monitoring.

In a tenth additional aspect, alone or in combination with one or more of the first through ninth aspects, the first PDCCH monitoring adaptation is indicated in the first LP-WUS via a first bitmap and the second PDCCH monitoring adaptation is indicated in the second LP-WUS via a second bitmap.

In an eleventh aspect, alone or in combination with one or more of the first through tenth aspects, process 500 includes transmitting a communication indicating a preferred PDCCH monitoring adaptation, wherein the preferred PDCCH monitoring adaptation is based at least in part on at least one of a traffic pattern prediction associated with the UE, power consumption of the UE, or a traffic latency requirement associated with the UE.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports an LP-WUS indicating a PDCCH monitoring adaptation in accordance with the present disclosure. Example process 600 is an example where the apparatus or the network node (for example, network node 110) performs operations associated with an LP-WUS indicating a PDCCH monitoring adaptation.

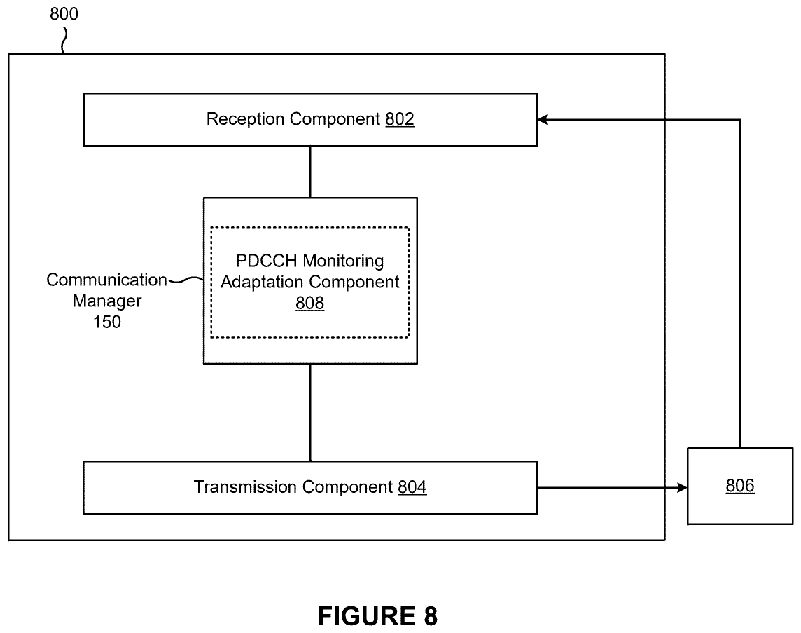

As shown in FIG. 6, in some aspects, process 600 may include enabling LP-WUSs indicating PDCCH monitoring adaptations for a UE (block 610). For example, the network node (such as by using communication manager 150 or PDCCH monitoring adaptation component 808, depicted in FIG. 8) may enable LP-WUSs indicating PDCCH monitoring adaptations for a UE, as described above.

As further shown in FIG. 6, in some aspects, process 600 may include transmitting an LP-WUS indicating a PDCCH monitoring adaptation to be applied by the UE, wherein the PDCCH monitoring adaptation is associated with at least one of PDCCH skipping or SSSG switching (block 620). For example, the network node (such as by using communication manager 150 or transmission component 804, depicted in FIG. 8) may transmit an LP-WUS indicating a PDCCH monitoring adaptation to be applied by the UE, wherein the PDCCH monitoring adaptation is associated with at least one of PDCCH skipping or SSSG switching, as described above.

Process 600 may include additional aspects, such as any single aspect or any combination of aspects described below or in connection with one or more other processes described elsewhere herein.

In a first additional aspect, process 600 includes deriving that LP-WUSs indicating PDCCH monitoring adaptations are to be enabled for the UE based at least in part on at least one of a traffic pattern associated with the UE, a radio condition associated with the UE, a mobility characteristic associated with the UE, a CCE usage characteristic, or a PDCCH blocking characteristic.

In a second additional aspect, alone or in combination with the first aspect, process 600 includes receiving capability information including an indication that the UE supports LP-WUSs indicating PDCCH monitoring adaptations.

In a third additional aspect, alone or in combination with one or more of the first and second aspects, process 600 includes transmitting a communication associated with enabling or configuring LP-WUSs indicating PDCCH monitoring adaptations on the UE.

In a fourth additional aspect, alone or in combination with one or more of the first through third aspects, the PDCCH monitoring adaptation indicates that the UE is to at least one of: deactivate or cease PDCCH skipping, perform PDCCH skipping for a duration of time, or refrain from monitoring one or more search space sets associated with one or more particular SSSGs, and perform monitoring of one or more other search space sets associated with one or more other particular SSSGs.

In a fifth additional aspect, alone or in combination with one or more of the first through fourth aspects, the PDCCH monitoring adaptation is indicated in the LP-WUS via a bitmap.

In a sixth additional aspect, alone or in combination with one or more of the first through fifth aspects, one or more bit values carried in the bitmap indicate a duration associated with PDCCH skipping.

In a seventh additional aspect, alone or in combination with one or more of the first through sixth aspects, one or more bit values carried in the bitmap indicate a scheme associated with SSSG switching.

In an eighth additional aspect, alone or in combination with one or more of the first through seventh aspects, the LP-WUS is a first LP-WUS and the PDCCH monitoring adaptation is a first PDCCH monitoring adaptation, and process 600 includes deriving that a second PDCCH monitoring adaptation is to be applied by the UE, and transmitting a second LP-WUS indicating a second PDCCH monitoring adaptation to be applied by the UE, the second LP-WUS being transmitted after the first LP-WUS.

In a ninth additional aspect, alone or in combination with one or more of the first through eighth aspects, the derivation that the second PDCCH monitoring adaptation is to be applied by the UE is based at least in part on at least one of a traffic pattern associated with the UE, a radio condition associated with the UE, a mobility characteristic associated with the UE, a CCE usage characteristic, or a PDCCH blocking characteristic.

In a tenth additional aspect, alone or in combination with one or more of the first through ninth aspects, the first PDCCH monitoring adaptation is indicated in the first LP-WUS via a bitmap carrying a first plurality of bit values, and the second PDCCH monitoring adaptation is indicated in the second LP-WUS via a bitmap carrying a second plurality of bit values.

In an eleventh additional aspect, alone or in combination with one or more of the first through tenth aspects, the LP-WUS is a first LP-WUS and the PDCCH monitoring adaptation is a first PDCCH monitoring adaptation, and process 600 includes transmitting a second LP-WUS indicating a second PDCCH monitoring adaptation to be applied by the UE, the second LP-WUS being transmitted after the first LP-WUS based on at least one of a traffic pattern change associated with the UE, a radio condition change associated with the UE, a mobility characteristic change associated with the UE, a CCE usage characteristic change, or a PDCCH blocking characteristic change.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports an LP-WUS indicating a PDCCH monitoring adaptation in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIG. 4. Additionally or alternatively, the apparatus 700 may be configured to and/or operable to perform one or more processes described herein, such as process 500 of FIG. 5. In some aspects, the apparatus 700 may include one or more components of the UE described above in connection with FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, one or more modems, one or more demodulators, one or more MIMO detectors, one or more receive processors, one or more controllers/processors, and/or one or more memories of the UE described above in connection with FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 704 may be co-located with the reception component 702 in one or more transceivers.

The communication manager 140 may receive or may cause the reception component 702 to receive an LP-WUS indicating a PDCCH monitoring adaptation to be applied by the UE wherein the PDCCH monitoring adaptation is associated with at least one of PDCCH skipping or SSSG switching. The communication manager 140 may adapt PDCCH monitoring performed by the UE according to the PDCCH monitoring adaptation indicated in the LP-WUS. In some aspects, the communication manager 140 may perform one or more operations described elsewhere herein as being performed by one or more components of the communication manager 140.

The communication manager 140 may include one or more controllers/processors, one or more memories of the UE described above in connection with FIG. 2. In some aspects, the communication manager 140 includes a set of components, such as a PDCCH monitoring adaptation component 708. Alternatively, the set of components may be separate and distinct from the communication manager 140. In some aspects, one or more components of the set of components may include or may be implemented within one or more controllers/processors, one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive an LP-WUS indicating a PDCCH monitoring adaptation to be applied by the UE, wherein the PDCCH monitoring adaptation is associated with at least one of PDCCH skipping or SSSG switching. The PDCCH monitoring adaptation component 708 may adapt PDCCH monitoring performed by the UE according to the PDCCH monitoring adaptation indicated in the LP-WUS.

The transmission component 704 may transmit capability information including an indication that the UE supports LP-WUSs indicating PDCCH monitoring adaptations.

The reception component 702 may receive a communication associated with enabling or configuring LP-WUSs indicating PDCCH monitoring adaptations on the UE.

FIG. 8 is a diagram of an example apparatus 800 for wireless communication that supports an LP-WUS indicating a PDCCH monitoring adaptation in accordance with the present disclosure. The apparatus 800 may be a network node, or a network node may include the apparatus 800. In some aspects, the apparatus 800 includes a reception component 802, a transmission component 804, and a communication manager 150, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIG. 4. Additionally or alternatively, the apparatus 800 may be configured to and/or operable to perform one or more processes described herein, such as process 600 of FIG. 6. In some aspects, the apparatus 800 may include one or more components of the network node described above in connection with FIG. 2.

The reception component 802 may receive communications, such as reference signals, control information, and/or data communications, from the apparatus 806. The reception component 802 may provide received communications to one or more other components of the apparatus 800, such as the communication manager 150. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the network node described above in connection with FIG. 2.

The transmission component 804 may transmit communications, such as reference signals, control information, and/or data communications, to the apparatus 806. In some aspects, the communication manager 150 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 804 may be co-located with the reception component 802 in one or more transceivers.

The communication manager 150 may enable LP-WUSs indicating PDCCH monitoring adaptations for a UE. The communication manager 150 may transmit or may cause the transmission component 804 to transmit an LP-WUS indicating a PDCCH monitoring adaptation to be applied by the UE, wherein the PDCCH monitoring adaptation is associated with at least one of PDCCH skipping or SSSG switching. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a PDCCH monitoring adaptation component 808. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The PDCCH monitoring adaptation component 708 may enable LP-WUSs indicating PDCCH monitoring adaptations for a UE. The transmission component 804 may transmit an LP-WUS indicating a PDCCH monitoring adaptation to be applied by the UE, wherein the PDCCH monitoring adaptation is associated with at least one of PDCCH skipping or SSSG switching.

The PDCCH monitoring adaptation component 808 may derive that LP-WUSs indicating PDCCH monitoring adaptations are to be enabled for the UE based at least in part on at least one of a traffic pattern associated with the UE, a radio condition associated with the UE, a mobility characteristic associated with the UE, a CCE usage characteristic, or a PDCCH blocking characteristic.

The reception component 802 may receive capability information including an indication that the UE supports LP-WUSs indicating PDCCH monitoring adaptations.

The transmission component 804 may transmit a communication associated with enabling or configuring LP-WUSs indicating PDCCH monitoring adaptations on the UE.

The following provides an overview of some Aspects of the present disclosure:

Aspect 1: A method of wireless communication performed at a user equipment (UE), comprising: receiving a low-power wake-up signal (LP-WUS) indicating a physical downlink control channel (PDCCH) monitoring adaptation to be applied by the UE, wherein the PDCCH monitoring adaptation is associated with at least one of PDCCH skipping or search space set group (SSSG) switching; and adapting PDCCH monitoring performed by the UE according to the PDCCH monitoring adaptation indicated in the LP-WUS.

Aspect 2: The method of Aspect 1, further comprising transmitting capability information including an indication that the UE supports LP-WUSs indicating PDCCH monitoring adaptations.

Aspect 3: The method of any of Aspects 1-2, further comprising receiving a communication associated with enabling or configuring LP-WUSs indicating PDCCH monitoring adaptations on the UE.

Aspect 4: The method of any of Aspects 1-3, wherein the PDCCH monitoring adaptation indicates that the UE is to at least one of: deactivate or cease PDCCH skipping; perform PDCCH skipping for a duration of time; or refrain from monitoring one or more search space sets associated with one or more particular SSSGs and perform monitoring of one or more other search space sets associated with one or more other particular SSSGs.

Aspect 5: The method of any of Aspects 1-4, wherein the PDCCH monitoring adaptation is indicated in the LP-WUS via a bitmap.

Aspect 6: The method of Aspect 5, wherein one or more bit values carried in the bitmap indicate a duration associated with PDCCH skipping.

Aspect 7: The method of Aspect 5, wherein one or more bit values carried in the bitmap indicate a monitoring scheme associated with SSSG switching.

Aspect 8: The method of any of Aspects 1-7, wherein the LP-WUS is a first LP-WUS and the PDCCH monitoring adaptation is a first PDCCH monitoring adaptation, and the method further comprises: receiving a second LP-WUS indicating a second PDCCH monitoring adaptation to be applied by the UE, the second LP-WUS being received after the first LP-WUS; and adapting the PDCCH monitoring performed by the UE according to the second PDCCH monitoring adaptation indicated in the second LP-WUS.

Aspect 9: The method of Aspect 8, wherein the second LP-WUS is received during a period of time in which the UE is not performing PDCCH monitoring.

Aspect 10: The method of Aspect 8, wherein the second LP-WUS is received during a period of time in which the UE is performing PDCCH monitoring.

Aspect 11: The method of Aspect 8, wherein the first PDCCH monitoring adaptation is indicated in the first LP-WUS via a first bitmap and the second PDCCH monitoring adaptation is indicated in the second LP-WUS via a second bitmap.

Aspect 12: The method of any of Aspects 1-11, further comprising transmitting a communication indicating a preferred PDCCH monitoring adaptation, wherein the preferred PDCCH monitoring adaptation is based at least in part on at least one of a traffic pattern prediction associated with the UE, power consumption of the UE, or a traffic latency requirement associated with the UE.

Aspect 13: A method of wireless communication performed at a network node, comprising: enabling low-power wake-up signals (LP-WUSs) indicating physical downlink control channel (PDCCH) monitoring adaptations for a user equipment (UE); and transmitting an LP-WUS indicating a PDCCH monitoring adaptation to be applied by the UE, wherein the PDCCH monitoring adaptation is associated with at least one of PDCCH skipping or search space set group (SSSG) switching.

Aspect 14: The method of Aspect 13, further comprising deriving that LP-WUSs indicating PDCCH monitoring adaptations are to be enabled for the UE based at least in part on at least one of a traffic pattern associated with the UE, a radio condition associated with the UE, a mobility characteristic associated with the UE, a CCE usage characteristic, or a PDCCH blocking characteristic.

Aspect 15: The method of any of Aspects 13-14, further comprising receiving capability information including an indication that the UE supports LP-WUSs indicating PDCCH monitoring adaptations.

Aspect 16: The method of any of Aspects 13-15, further comprising transmitting a communication associated with enabling or configuring LP-WUSs indicating PDCCH monitoring adaptations on the UE.

Aspect 17: The method of any of Aspects 13-16, wherein the PDCCH monitoring adaptation indicates that the UE is to at least one of: deactivate or cease PDCCH skipping; perform PDCCH skipping for a duration of time; or refrain from monitoring one or more search space sets associated with one or more particular SSSGs and perform monitoring of one or more search space sets associated with one or more other particular SSSGs.

Aspect 18: The method of any of Aspects 13-17, wherein the PDCCH monitoring adaptation is indicated in the LP-WUS via a bitmap.

Aspect 19: The method of Aspect 18, wherein one or more bit values carried in the bitmap indicate a duration associated with PDCCH skipping.

Aspect 20: The method of Aspect 18, wherein one or more bit values carried in the bitmap indicate a scheme associated with SSSG switching.

Aspect 21: The method of any of Aspects 13-20, wherein the LP-WUS is a first LP-WUS and the PDCCH monitoring adaptation is a first PDCCH monitoring adaptation, and the method further comprises: deriving that a second PDCCH monitoring adaptation is to be applied by the UE; and transmitting a second LP-WUS indicating a second PDCCH monitoring adaptation to be applied by the UE, the second LP-WUS being transmitted after the first LP-WUS.

Aspect 22: The method of Aspect 21, wherein the derivation that the second PDCCH monitoring adaptation is to be applied by the UE is based at least in part on at least one of a traffic pattern associated with the UE, a radio condition associated with the UE, a mobility characteristic associated with the UE, a CCE usage characteristic, or a PDCCH blocking characteristic.

Aspect 23: The method of Aspect 21, wherein the first PDCCH monitoring adaptation is indicated in the first LP-WUS via a bitmap carrying a first plurality of bit values and the second PDCCH monitoring adaptation is indicated in the second LP-WUS via a bitmap carrying a second plurality of bit values.

Aspect 24: The method of any of Aspects 13-23, wherein the LP-WUS is a first LP-WUS and the PDCCH monitoring adaptation is a first PDCCH monitoring adaptation, and the method further comprises: transmitting a second LP-WUS indicating a second PDCCH monitoring adaptation to be applied by the UE, the second LP-WUS being transmitted after the first LP-WUS based on at least one of a traffic pattern change associated with the UE, a radio condition change associated with the UE, a mobility characteristic change associated with the UE, a CCE usage characteristic change, or a PDCCH blocking characteristic change.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus at a user equipment (UE) for wireless communication, comprising:
one or more memories storing processor-executable code; and
one or more processors coupled with the one or more memories, at least one processor of the one or more processors configured to cause the UE to:
receive a low-power wake-up signal (LP-WUS) indicating a physical downlink control channel (PDCCH) monitoring adaptation to be applied by the UE, wherein the PDCCH monitoring adaptation is associated with at least one of PDCCH skipping or search space set group (SSSG) switching; and
adapt PDCCH monitoring performed by the UE according to the PDCCH monitoring adaptation indicated in the LP-WUS.

2. The apparatus of claim 1, wherein at least one processor of the one or more processors is configured to cause the UE to transmit capability information including an indication that the UE supports LP-WUSs indicating PDCCH monitoring adaptations.

3. The apparatus of claim 1, wherein at least one processor of the one or more processors is configured to cause the UE to receive a communication associated with enabling or configuring LP-WUSs indicating PDCCH monitoring adaptations on the UE.

4. The apparatus of claim 1, wherein the PDCCH monitoring adaptation indicates that the UE is to at least one of:
deactivate or cease PDCCH skipping;
perform PDCCH skipping for a duration of time; or
refrain from monitoring one or more search space sets associated with one or more particular SSSGs and perform monitoring of one or more other search space sets associated with one or more other particular SSSGs.

5. The apparatus of claim 1, wherein the PDCCH monitoring adaptation is indicated in the LP-WUS via a bitmap.

6. The apparatus of claim 5, wherein one or more bit values carried in the bitmap indicate a duration associated with PDCCH skipping.

7. The apparatus of claim 5, wherein one or more bit values carried in the bitmap indicate a monitoring scheme associated with SSSG switching.

8. The apparatus of claim 1, wherein the LP-WUS is a first LP-WUS and the PDCCH monitoring adaptation is a first PDCCH monitoring adaptation, and at least one processor of the one or more processors is further configured to:
receive a second LP-WUS indicating a second PDCCH monitoring adaptation to be applied by the UE, the second LP-WUS being received after the first LP-WUS; and
adapt the PDCCH monitoring performed by the UE according to the second PDCCH monitoring adaptation indicated in the second LP-WUS.

9. The apparatus of claim 8, wherein the second LP-WUS is received during a period of time in which the UE is not performing PDCCH monitoring.

10. The apparatus of claim 8, wherein the second LP-WUS is received during a period of time in which the UE is performing PDCCH monitoring.

11. The apparatus of claim 8, wherein the first PDCCH monitoring adaptation is indicated in the first LP-WUS via a first bitmap and the second PDCCH monitoring adaptation is indicated in the second LP-WUS via a second bitmap.

12. The apparatus of claim 1, wherein at least one processor of the one or more processors is configured to cause the UE to transmit a communication indicating a preferred PDCCH monitoring adaptation, wherein the preferred PDCCH monitoring adaptation is based at least in part on at least one of a traffic pattern prediction associated with the UE, power consumption of the UE, or a traffic latency requirement associated with the UE.

13. An apparatus at a network node for wireless communication, comprising:
one or more memories storing processor-executable code; and
one or more processors coupled with the one or more memories, at least one processor of the one or more processors configured to cause the network node to:
enable low-power wake-up signals (LP-WUSs) indicating physical downlink control channel (PDCCH) monitoring adaptations for a user equipment (UE); and
transmit an LP-WUS indicating a PDCCH monitoring adaptation to be applied by the UE, wherein the PDCCH monitoring adaptation is associated with at least one of PDCCH skipping or search space set group (SSSG) switching.

14. The apparatus of claim 13, wherein at least one processor of the one or more processors is configured to cause the network node to derive that LP-WUSs indicating PDCCH monitoring adaptations are to be enabled for the UE based at least in part on at least one of a traffic pattern associated with the UE, a radio condition associated with the UE, a mobility characteristic associated with the UE, control channel element usage characteristic, or PDCCH blocking characteristic.

15. The apparatus of claim 13, wherein at least one processor of the one or more processors is configured to cause the network node to receive capability information including an indication that the UE supports LP-WUSs indicating PDCCH monitoring adaptations.

16. The apparatus of claim 13, wherein at least one processor of the one or more processors is configured to cause the network node to transmit a communication associated with enabling or configuring LP-WUSs indicating PDCCH monitoring adaptations on the UE.

17. The apparatus of claim 13, wherein the PDCCH monitoring adaptation is indicated in the LP-WUS via a bitmap.

18. The apparatus of claim 13, wherein the LP-WUS is a first LP-WUS and the PDCCH monitoring adaptation is a first PDCCH monitoring adaptation, and at least one processor of the one or more processors is configured to:
derive that a second PDCCH monitoring adaptation is to be applied by the UE; and
transmit a second LP-WUS indicating a second PDCCH monitoring adaptation to be applied by the UE, the second LP-WUS being transmitted after the first LP-WUS.

19. The apparatus of claim 13, wherein the LP-WUS is a first LP-WUS and the PDCCH monitoring adaptation is a first PDCCH monitoring adaptation, and at least one processor of the one or more processors is configured to:
transmit a second LP-WUS indicating a second PDCCH monitoring adaptation to be applied by the UE, the second LP-WUS being transmitted after the first LP-WUS based on at least one of a traffic pattern change associated with the UE, a radio condition change associated with the UE, a mobility characteristic change associated with the UE, a CCE usage characteristic change, or a PDCCH blocking characteristic change.

20. A method of wireless communication performed at a user equipment (UE), comprising:
receiving a low-power wake-up signal (LP-WUS) indicating a physical downlink control channel (PDCCH) monitoring adaptation to be applied by the UE,
wherein the PDCCH monitoring adaptation is associated with at least one of PDCCH skipping or search space set group (SSSG) switching; and
adapting PDCCH monitoring performed by the UE according to the PDCCH monitoring adaptation indicated in the LP-WUS.
